(19) United States
(12) Patent Application Publication
(10) Pub. No.: US 2014/0170434 A1
(43) Pub. Date: Jun. 19, 2014

(54) Two Layer Ag Process For Low Emissivity Coatings

(71) Applicant: INTERMOLECULAR INC., San Jose, CA (US)

(72) Inventors: Mohd Fadzli Anwar Hassan, San Francisco, CA (US); Brent Boyce, Novi, MI (US); Guowen Ding, San Jose, CA (US); Minh Huu Le, San Jose, CA (US); Zhi-Wen Wen Sun, Sunnyvale, CA (US); Yu Wang, San Jose, CA (US); Yongli Xu, Plymouth, MI (US)

(73) Assignee: INTERMOLECULAR INC., San Jose, CA (US)

(21) Appl. No.: 13/715,709

(22) Filed: Dec. 14, 2012

(51) Int. Cl. G02B 1/10

(52) U.S. Cl. CPC G02B 1/10
USPC 428/552; 428/632; 427/164

(57) ABSTRACT

Two layer silver process comprising a silver layer deposited on a doped silver layer can improve the adhesion of the silver layer on a substrate, minimizing agglomeration to provide a high quality silver layer. The doped silver layer can comprise silver and a doping element that has lower enthalpy of formation with oxide than that of silver, leading to better bonding with oxygen in the substrate.

### FIELD OF THE INVENTION

The present invention relates to low emissivity panels, and more particularly to low-e panels having improved infrared reflective layer and methods for forming such low-e panels.

### BACKGROUND OF THE INVENTION

Sunlight control glasses are commonly used in applications such as building glass windows and vehicle windows, typically offering high visible transmission and low emissivity. High visible transmission can allow more sunlight to pass through the glass windows, thus being desirable in many window applications. Low emissivity can block infrared (IR) radiation to reduce undesirable interior heating.

In low emissivity glasses, IR radiation is mostly reflected with minimum absorption and emission, thus reducing the heat transferring to and from the low emissivity surface. Typical sunlight control glasses have generally an emissivity of about 0.1 and a light transmission of about 80%. High transmittance, low emissivity glasses generally include a reflective metal film (e.g., silver) to provide infrared reflectance and low emissivity, along with various dielectric layers, such as tin oxide or zinc oxide, to provide a barrier to prevent oxidation or corrosion, as well as to act as optical fillers and function as anti-reflective coating layers to improve the optical characteristics of the glass panel.

The overall quality of the reflective layer, for example, its crystallographic orientation, is important for achieving the desired performance, such as high visible light transmission and low emissivity (i.e., high heat reflection). One known method to achieve low emissivity is to form a relatively thick silver layer. However, as the thickness of the silver layer increases, the visible light transmission of the reflective layer is reduced, as is manufacturing throughput, while overall manufacturing costs are increased. Therefore, is it desirable to form the silver layer as thin as possible, while still providing emissivity that is suitable for low-e applications.

### SUMMARY OF THE DESCRIPTION

In some embodiments, the present invention discloses methods and apparatuses for making low emissivity panels which comprise high adhesion of a low resistivity thin infrared reflective layer, such as silver, which can be achieved by a bottom layer comprising doped silver. The improved adhesion can reduce the amount of agglomeration during the silver layer formation, promoting a better (111) texture for better quality silver. High quality silver layer can provide better electrical property, leading to thinner thickness of silver layer and better visible light transmission.

In some embodiments, the present invention discloses methods and materials for improving the adhesion of a silver layer on a substrate, comprising a bottom layer of doped silver using a dopant that can easily form oxides to create a strong bond with the substrate, or with an underlayer or a seed layer disposed on the substrate. The doping element can comprise an element that has a lower enthalpy of oxide formation as compare to that of silver, or has a lower enthalpy of oxide formation as compare to that of the underlayer. The thickness of the bottom layer can be less than about 5 nm, and preferably between about 0.5 nm and 3 nm.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1A illustrates an exemplary thin film coating according to some embodiments.

FIG. 1B illustrates a low emissivity transparent panel according to some embodiments.

FIGS. 2A-2B illustrates exemplary physical vapor deposition (PVD) systems according to some embodiments.

FIGS. 3A-3B illustrate an exemplary layer stack comprising a bottom layer according to some embodiments.

FIG. 4 illustrates an exemplary in-line deposition system according to some embodiments.

FIG. 5 illustrates an exemplary flow chart for two layer silver deposition.

FIG. 6 illustrates another exemplary flow chart for two layer silver deposition.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

In some embodiments, the present invention discloses methods, and coated panels fabricated from the methods, for forming a low-e panel with improved overall quality of an infrared reflective layer (such as silver, gold or copper), comprising forming a bottom layer between a seed layer for the infrared reflective layer and the infrared reflective layer. The bottom layer can act as an adhesion layer for the infrared reflective layer, which can reduce the film roughness of the infrared reflective layer, leading to thinner infrared reflective layers with similar conductivity.

In some embodiments, the present invention discloses methods and apparatuses for making low emissivity panels which comprise high adhesion of a silver layer, which can be achieved by using a doped silver layer as a bottom layer between the silver layer and a seed underlayer such as a zinc oxide containing layer. The improved adhesion can reduce the amount of agglomeration during the silver layer formation, promoting a better (111) texture for better quality silver. High quality silver layer can provide better electrical property, leading to thinner thickness of silver layer and better visible light transmission.

Generally, it is preferable to form the infrared reflective layer in such a way that visible light transmission is high and emissivity is low. It is also preferable to maximize volume production, throughput, and efficiency of the manufacturing process used to form low-e panels.

For example, with an infrared reflective layer comprising silver, it is preferably for the silver layer to have <111> crystallographic orientation because it allows for the silver layer to have relatively high electrical conductivity, and thus relatively low sheet resistance (Rs) at thin layer thickness. Thin layer thickness is desirable to provide high visible light transmission, and low sheet resistance is preferred low sheet resistance can offer low infrared emissivity.

To promote the crystal orientation of the infrared reflective layer, a seed layer can be used. Generally, seed layers are relatively thin layers of materials formed on a surface (e.g., a substrate) to promote a particular characteristic of a subsequent layer formed over the surface (e.g., on the seed layer). For example, seed layers may be used to improve adhesion between the subsequent layer and the substrate or increase the rate at which the subsequent layer is grown on the substrate during the respective deposition process.

A seed layer can also affect the crystalline structure (or crystallographic orientation) of the subsequent layer, which is sometimes referred to as “templating.” For example, the interaction of the material of the subsequent layer with the crystalline structure of the seed layer causes the crystalline structure of the subsequent layer to be formed in a particular orientation.

For example, a seed layer can be used to promote growth of the infrared reflective layer in a particular crystallographic orientation. For example, a seed layer can comprise a material with a hexagonal crystal structure and can be formed with a (002) crystallographic orientation (such as zinc oxide or doped zinc oxide), which promotes growth of a silver layer in the (111) orientation when the silver layer has a face centered cubic crystal. Thus the seed layer can improve the conductivity of the deposited silver layer such that the thickness of the silver layer may be reduced while still providing the desirably low emissivity. In some embodiments, the formation of a high conductivity and thin silver layer can be achieved by forming a relatively thin (e.g., up to about 5 nm) seed layer of, for example, zinc oxide or doped zinc oxide on the substrate, before depositing the silver layer.

In some embodiments, the present invention discloses methods, and coated panels formed using the methods, to improve the quality of a silver layer, e.g., high conductivity for low emissivity property in glass coating, comprising forming a doped silver layer between the seed layer and the silver layer. For example, a doped silver layer can have better bonding characteristics with oxygen in the zinc oxide seed layer, and thus can serve to improve the quality of the subsequently deposited silver on the doped silver layer.

In some embodiments, the present invention recognizes that silver has low tendency to form silver oxide, and thus can exhibit poor adhesion with an oxide underlayer, such as a zinc oxide underlayer, serving as a seed layer for promoting (111) crystal orientation of the silver layer. In some embodiments, the present invention discloses methods and materials for improving adhesion of a silver layer on a substrate, comprising doping the silver layer with a dopant that can easily form oxides to create a strong bond with the substrate, or with an underlayer disposed on the substrate. In some embodiments, the doped silver layer can form oxides during the formation of the doped silver layer, or during any subsequent process steps.

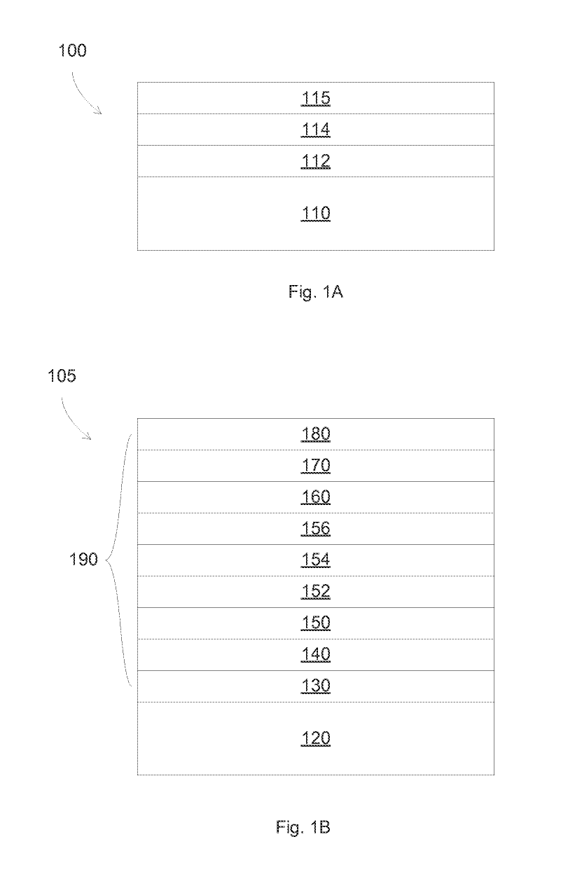

FIG. 1A illustrates an exemplary thin film coating according to some embodiments of the present invention. An infrared reflective layer, such as a silver layer 115, is disposed on a bottom layer 114 which comprises a doped material of the infrared reflective layer. For example, an infrared reflective layer comprising silver can be disposed on a bottom layer comprising doped silver. The bottom layer 114 is disposed on an oxide layer 112, such as an oxide seed layer of zinc oxide, which is disposed on a substrate 110 to form a coated transparent panel 100, which has high visible light transmission, and low IR emission. The zinc oxide seed layer 112 preferably comprises (002) crystal orientation to promote a (111) crystal orientation of the silver layer 115. As shown, silver layer 115 and doped silver layer 114 are distinct layers, but other configurations are also within the scope of the present invention, such as a silver layer and a doped silver layer without any clear interface, or a gradual transition interface from doped silver to silver layer. The dopants for doped silver layer can comprise elements that can bond easily with oxygen (as compared to silver) to promote bonding with the oxide underlayer, such as Ti, Si, Pd, Cr, Ni, Zr, Mn, Fe, Ta, Pt, or Zn. Other dopants can also be used.

The layers 112, 114, and/or 115 can be sputtered deposited using different processes and equipment, for example, the targets can be sputtered under direct current (DC), pulsed DC, alternate current (AC), radio frequency (RF) or any other suitable conditions. In some embodiments, the present invention discloses a physical vapor deposition method for depositing the layers 112, 114, and/or 115. The deposition process can comprise a gas mixture introduced to a plasma ambient to sputtering material from one or more targets disposed in the processing chamber. The sputtering process can further comprise other components such as magnets for confining the plasma, and utilize different process conditions such as DC, AC, RF, or pulse sputtering.

In some embodiments, the present invention discloses a coating stack, comprising multiple layers for different functional purposes. For example, the coating stack can comprise a seed layer to facilitate the deposition of the reflective layer, a bottom layer comprising a doped layer to facilitate the adhesion with the subsequently deposited infrared reflective layer, an infrared reflective layer, an oxygen diffusion barrier layer disposed on the reflective layer to prevent oxidation of the reflective layer, a protective layer disposed on the substrate to prevent physical or chemical abrasion, or an antireflective layer to reduce visible light reflection. The coating stack can comprise multiple layers of reflective layers to improve IR emissivity.

FIG. 1B illustrates a low emissivity transparent panel 105 according to some embodiments of the present invention. The low emissivity transparent panel can comprise a glass substrate 120 and a low-e stack 190 formed over the glass substrate 120. The glass substrate 120 in one embodiment is made of a low emissivity glass, such as borosilicate glass, and has a thickness of, for example, between 1 and 10 millimeters (mm). The substrate 120 may be square or rectangular and about 0.5-2 meters (m) across. In some embodiments, the substrate 120 may be made of, for example, plastic or polycarbonate.

The low-e stack 190 includes a lower protective layer 130, a lower oxide layer 140, a seed layer 150, a bottom layer 152, a reflective layer 154, a barrier layer 156, an upper oxide 160, an optical filler layer 170, and an upper protective layer 180. Some layers can be optional, and other layers can be added, such as a base layer. Exemplary details as to the functionality provided by each of the layers 130-180 are provided below.

The various layers in the low-e stack 190 may be formed sequentially (i.e., from bottom to top) on the glass substrate 120 using a physical vapor deposition (PVD) and/or reactive (or plasma enhanced) sputtering processing tool. In one embodiment, the low-e stack 190 is formed over the entire glass substrate 120. However, in other embodiments, the low-e stack 190 may only be formed on isolated portions of the glass substrate 120.

The lower protective layer 130 is formed on the upper surface of the glass substrate 120. The lower protective layer 130 can comprise silicon nitride, silicon oxynitride, or other nitride material such as SiZrN, for example, to protect the other layers in the stack 190 from diffusion from the substrate 120 or to improve the haze reduction properties. In some embodiments, the lower protective layer 130 is made of silicon nitride and has a thickness of, for example, between about 10 nm to 50 nm, such as 25 nm.

The lower oxide layer 140 is formed on the lower protective layer 130 and over the glass substrate 120. The lower oxide layer 140 is preferably a metal oxide or metal alloy oxide layer and can serve as an antireflective layer.

The seed layer 150 can be used to provide a seed layer for the IR reflective film, for example, a zinc oxide layer deposited before the deposition of a silver reflective layer can provide a silver layer with lower resistivity, which can improve its reflective characteristics. The seed layer can comprise zinc oxide or doped zinc oxide.

In some embodiments, the seed layer 150 can be continuous and covers the entire substrate. For example, the thickness of the seed layer can be less than about 10 nm, and preferably less than about 5 nm. Alternatively, the seed layer 150 may not be formed in a completely continuous manner. The seed layer can be distributed across the substrate surface such that each of the seed layer areas is laterally spaced apart from the other seed layer areas across the substrate surface and do not completely cover the substrate surface. For example, the thickness of the seed layer 150 can be a monolayer or less, such as between 0.2 and 0.4 nm, and the separation between the layer sections may be the result of forming such a thin seed layer (i.e., such a thin layer may not form a continuous layer).

The reflective layer 154 is formed on the seed layer 150 through a bottom layer 152. The reflective layer can be a metallic, reflective film, such as gold, copper, or silver. In general, the reflective film comprises a good electrical conductor, blocking the passage of thermal energy. In some embodiments, the reflective layer 154 is made of silver and has a thickness of, for example, 10 nm. Because the reflective layer 154 is formed on the seed layer 150, for example, due to the <002> crystallographic orientation of the seed layer 150, growth of the silver reflective layer 154 in a <111> crystalline orientation is promoted, which offers low sheet resistance, leading to low panel emissivity.

Because of the promoted <111> texturing orientation of the reflective layer 154 caused by the seed layer 150, the conductivity and emissivity of the reflective layer 154 is improved. As a result, a thinner reflective layer 154 may be formed that still provides sufficient reflective properties and visible light transmission. Additionally, the reduced thickness of the reflective layer 154 allows for less material to be used in each panel that is manufactured, thus improving manufacturing throughput and efficiency, increasing the usable life of the target (e.g., silver) used to form the reflective layer 154, and reducing overall manufacturing costs.

In some embodiments, the crystallographic orientation can be characterized by X-ray diffraction (XRD) technique, which is based on observing the scattered intensity of an X-ray beam hitting the layer, e.g., silver layer or seed layer, as a function of the X-ray characteristics, such as the incident and scattered angles. For example, zinc oxide seed layer can show a pronounced (002) peak and higher orders in a 8-28 diffraction pattern. This suggests that zinc oxide crystallites with the respective planes oriented parallel to the substrate surface are present.

In some embodiments, the terms “silver layer having (111) crystallographic orientation”, or “zinc oxide seed layer having (002) crystallographic orientation” comprise a meaning that there is a (111) preferred crystallographic orientation for the silver layer or a (002) preferred crystallographic orientation for the zinc oxide seed layer, respectively. The preferred crystallographic orientation can be determined, for example, by observing pronounced crystallography peaks in an XRD characterization.

The seed layers 150 can provide a barrier between the metal oxide layer 140 and the reflective layer 154 to reduce the likelihood of any reaction of the material of the reflective layer 154 and the oxygen in the lower metal oxide layer 140, especially during subsequent heating processes. As a result, the resistivity of the reflective layer 154 may be reduced, thus increasing performance of the reflective layer 154 by lowering the emissivity.

In some embodiments, the present invention discloses a bottom layer 152, which can serve as an adhesion promoter for the silver layer 154 with the ZnO seed layer 150. The bottom layer 152 can improve the bonding characteristics of the silver layer with the underlying seed layer 150 without significantly affecting the templating functionality of the seed layer 150.

In some embodiments, the bottom layer 152 can comprise materials that can be easily bonded with oxygen, such as materials having tendency to form oxide to bond with the oxygen of the oxide seed layer. The bottom layer further comprises low resistivity materials to improve the infrared reflectivity property.

In some embodiments, the bottom layer comprises doped silver layer. The percentage of the dopant is preferably less than about 5 wt %, for example, in order to minimize the effect of potentially resistance increase due to the dopant. The dopant materials can be elements that have high conductivity, such as metallic elements, for example, to increase electrical conductivity. The dopant materials can be elements that have higher tendency to form oxide as compared to silver, in order to improve the bonding strength with the underlying oxide seed layer. In some embodiments, the dopant materials can be elements that have higher tendency to form oxide as compared to zinc, in order to take away the oxygen that has been bonded to the zinc oxide seed layer.

In some embodiments, the bottom layer can be continuous and covers the entire substrate, with thickness less than about 3 nm, and preferably more than about 0.5 nm. Alternatively, the bottom layer may not be formed in a completely continuous manner. The thickness of the bottom layer can be a monolayer or less, such as between 0.2 and 0.4 nm.

Formed on the reflective layer 154 is a barrier layer 156, which can protect the reflective layer 154 from being oxidized. For example, the barrier layer can be a diffusion barrier, stopping oxygen from diffusing into the silver layer from the upper oxide layer 160. The barrier layer 156 can comprise titanium, nickel or a combination of nickel and titanium.

Formed on the barrier layer 156 is an upper oxide layer 160, which can function as an antireflective film stack, including a single layer or multiple layers for different functional purposes. The antireflective layer 160 serves to reduce the reflection of visible light, selected based on transmittance, index of refraction, adherence, chemical durability, and thermal stability. In some embodiments, the antireflective layer 160 comprises tin oxide, offering high thermal stability properties. The antireflective layer 160 can comprise titanium dioxide, silicon nitride, silicon dioxide, silicon oxynitride, niobium oxide, SiZrN, tin oxide, zinc oxide, or any other suitable dielectric material.

Formed on the antireflective layer 160 is an optical filler layer 170. The optical filler layer 170 can be used to provide a proper thickness to the low-e stack, for example, to provide an antireflective property. The optical filler layer preferably has high visible light transmittance. In some embodiments, the optical filler layer 170 is made of tin oxide and has a thickness of, for example, 100 Å. The optical filler layer may be used to tune the optical properties of the low-e panel 105. For example, the thickness and refractive index of the optical filler layer may be used to increase the layer thickness to a multiple of the incoming light wavelengths, effectively reducing the light reflectance and improving the light transmittance.

Formed on the optical filler layer 170 is an upper protective layer 180. An upper protective layer 180 can be used for protecting the total film stack, for example, to protect the panel from physical or chemical abrasion. The upper protective layer 180 can be an exterior protective layer, such as silicon nitride, silicon oxynitride, titanium oxide, tin oxide, zinc oxide, niobium oxide, or SiZrN.

In some embodiments, adhesion layers can be used to provide adhesion between layers. The adhesion layers can be made of a metal alloy, such as nickel-titanium, and have a thickness of, for example, 3 nm.

It should be noted that depending on the exact materials used, some of the layers of the low-e stack 190 may have some materials in common. An example of such a stack may use a zinc-based material in the oxide dielectric layers 140 and 160. As a result, a relatively low number of different targets can be used for the formation of the low-e stack 190.

In some embodiments, the coating can comprise a double or triple layer stack, having multiple IR reflective layers. In some embodiments, the layers can be formed using a plasma enhanced, or reactive sputtering, in which a carrier gas (e.g., argon) is used to eject ions from a target, which then pass through a mixture of the carrier gas and a reactive gas (e.g., oxygen), or plasma, before being deposited.

The coated transparent panels can comprise a glass substrate or any other transparent substrates, such as substrates made of organic polymers. The coated transparent panels can be used in window applications such as vehicle and building windows, skylights, or glass doors, either in monolithic glazing or multiple glazing with or without a plastic interlayer or a gas-filled sealed interspace.

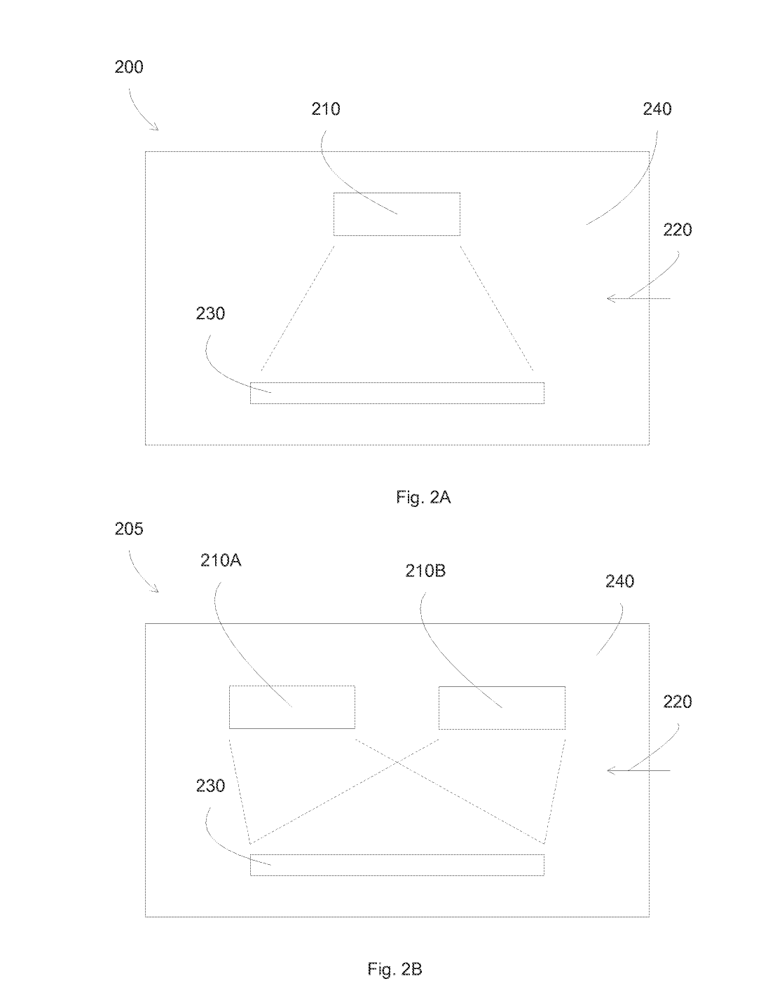

FIGS. 2A-2B illustrate exemplary physical vapor deposition (PVD) systems according to some embodiments of the present invention. The PVD system, also commonly called sputter system or sputter deposition system, 200 includes a housing that defines, or encloses, a processing chamber 240, a substrate 230, a target assembly 210, and reactive species delivered from an outside source 220. The substrate can be stationary, or in some manufacturing environments, the substrate may be in motion during the deposition processes. During deposition, the target is bombarded with argon ions, which releases sputtered particles toward the substrate 230. The sputter system 200 can perform blanket deposition on the substrate 230, forming a deposited layer that cover the whole substrate, e.g., the area of the substrate that can be reached by the sputtered particles generated from the target assembly 210.

In FIG. 2B, a sputter deposition chamber 205 comprises two target assemblies 210A and 210B disposed in the processing chamber 240, containing reactive species delivered from an outside source 220. The target assemblies 210A and 210B can comprise the dopant and silver to deposit a doped silver layer on substrate 230. This configuration is exemplary, and other sputter system configurations can be used, such as a single target as above, comprising and alloy of dopant and silver.

The materials used in the target assembly 210 (FIG. 2A) may, for example, include Ag, Ti, Si, Pd, Cr, Ni, Zr, Mn, Fe, Ta, Pt, Zn, Sn, Mg, Al, La, Y, Sb, Sr, Bi, or any combination thereof (i.e., a single target may be made of an alloy of several metals). Additionally, the materials used in the targets may include oxygen, nitrogen, or a combination of oxygen and nitrogen in order to form the oxides, nitrides, and oxynitrides described above. Additionally, although only one target assembly 210 is shown (FIG. 2A), additional target assemblies may be used (e.g. FIG. 2B). As such, different combinations of targets may be used to form, for example, the dielectric layers described above. For example, in an embodiment in which the dielectric material is zinc-tin-titanium oxide, the zinc, the tin, and the titanium may be provided by separate zinc, tin, and titanium targets, or they may be provided by a single zinc-tin-titanium alloy target. For example, the target assembly 210 can comprise a silver target, and together with argon ions, sputter deposit a silver layer on substrate 230. The target assembly 210 can comprise a metal or metal alloy target, such as Ag, Ti, or Ti—Ag alloy, to sputter deposit silver or doped silver layers.

The sputter deposition system 200 can comprise other components, such as a substrate support for supporting the substrate. The substrate support can comprise a vacuum chuck, electrostatic chuck, or other known mechanisms. The substrate support can be capable of rotating around an axis thereof that is perpendicular to the surface of the substrate. In addition, the substrate support may move in a vertical direction or in a planar direction. It should be appreciated that the rotation and movement in the vertical direction or planar direction may be achieved through known drive mechanisms which include magnetic drives, linear drives, worm screws, lead screws, a differentially pumped rotary feed through drive, etc.

In some embodiments, the substrate support includes an electrode which is connected to a power supply, for example, to provide a RF or dc bias to the substrate, or to provide a plasma environment in the process housing 240. The target assembly 210 can include an electrode which is connected to a power supply to generate a plasma in the process housing. The target assembly 210 is preferably oriented towards the substrate 230.

The sputter deposition system 200 can also comprise a power supply coupled to the target electrode. The power supply provides power to the electrodes, causing material to be, at least in some embodiments, sputtered from the target. During sputtering, inert gases, such as argon or krypton, may be introduced into the processing chamber 240 through the gas inlet 220. In embodiments in which reactive sputtering is used, reactive gases may also be introduced, such as oxygen and/or nitrogen, which interact with particles ejected from the targets to form oxides, nitrides, and/or oxynitrides on the substrate.

The sputter deposition system 200 can also comprise a control system (not shown) having, for example, a processor and a memory, which is in operable communication with the other components and configured to control the operation thereof in order to perform the methods described herein.

In some embodiments, the present invention discloses methods to form low-e panels, comprising forming a bottom layer comprising a doped material between a seed layer and an infrared reflective layer. In some embodiments, a transparent substrate is provided. A seed layer is formed over the transparent substrate. The seed layer can comprise zinc oxide or doped zinc oxide material. The seed layer preferably comprises (002) crystal orientation. For example, more than about 30% of the seed layer has a <002> crystallographic orientation. A bottom layer comprising a doped silver layer is formed on the seed layer, for example, to promote an adhesion bonding between the seed layer and the subsequently deposited silver layer. A silver layer is then formed on the bottom layer. The silver layer preferably comprises (111) crystal orientation.

In some embodiments, the bottom layer can improve the adhesion between the zinc oxide seed layer and the silver layer, for example, through a dopant material that has strong tendency to form oxide.

In some embodiments, the bottom layer 114 or 152 is continuous and covers the entire lower metal oxide layer 112 or 150. In some embodiments, the bottom layer may not be formed in a completely continuous manner.

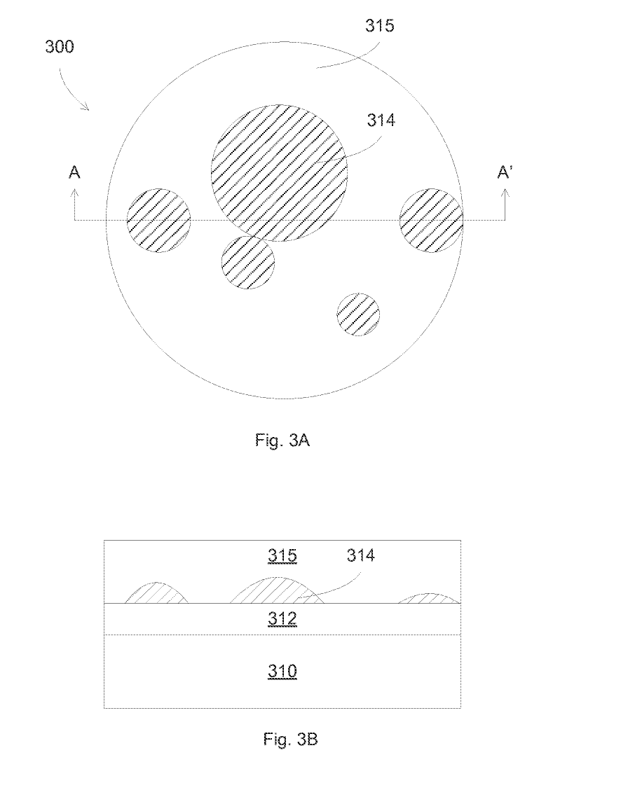

FIGS. 3A-3B illustrate an exemplary layer stack comprising a bottom layer according to some embodiments of the present invention. FIG. 3A shows a top view, and FIG. 3B shows a cross section AA′ of a same layer stack. A silver layer 315 is disposed on a bottom layer 314 which comprises a doped silver material. The bottom layer 314 is disposed on a zinc oxide layer 312, which is disposed on a substrate 310 to form a coated transparent panel 300. In some embodiments, the dopants for doped silver layer can comprise elements that can bond easily with oxygen (as compared to silver) to promote bonding with the oxide underlayer, such as Ti, Si, Pd, Cr, Ni, Zr, Mn, Fe, Ta, Pt, or Zn. Other dopants can also be used.

The bottom layer 314 can comprise a plurality of sections or portions, which are distributed across the lower zinc oxide layer 312 such that some of the sections are laterally spaced apart from other layer sections across the lower zinc oxide layer 312 and do not completely cover the lower zinc oxide layer 312. Some of the sections can overlap, or be adjacent to each other. In some embodiments, the bottom layer 314 and/or the bottom layer sections may have a thickness of, for example, between about 0.2 nm and about 0.4 nm, and the separation between the bottom layer sections may be the result of forming such a thin layer (i.e., such a thin layer may not form a continuous layer).

In some embodiments, the bottom layer 314 with the individual sections may represent a state of a continuous interface layer during the formation thereof, before a desired thickness (e.g., 5 nm) is achieved. That is, the bottom layer sections may form during the initial deposition of the bottom layer, and may subsequent grow together to form a continuous interface layer.

In some embodiments, the two layers of doped and undoped infrared reflective material (e.g., doped silver and silver) can be considered as two separate layers or an integrated layer with two portions of doped and undoped. The doped and undoped portions can have sharp interface or can have a transitional interface where the two portions are mixed.

In some embodiments, the bottom doped silver layer serves as an adhesion promoter for the subsequently deposited undoped silver. Thus the doped silver layer is deposited on an underlayer, e.g., a seed layer for silver, to achieve a good bonding interface with the underlayer.

In some embodiments, the bottom layer is formed on the underlayer by deposition, e.g., the bottom layer is not formed by an interface diffusion or reaction with the underlayer. For example, the present invention discloses depositing a doped silver layer on an underlayer, and not depositing an undoped silver layer on the underlayer, followed by an annealing process to promote interface diffusion or reaction between the undoped silver layer and the underlayer to form a doped silver layer.

In some embodiments, the present invention discloses an in-situ formation of a doped silver layer on a zinc oxide seed layer, a silver layer on a doped silver oxide, or a silver layer on a doped silver oxide on a zinc oxide layer, without exposure to atmosphere. By controlling the surface of the seed layer or the bottom layer, for example, to reduce any possible surface contamination, the quality of the silver layer can be further promoted and not impeded by any adhered particulates.

For example, a layer of doped silver can be deposited on a substrate, such as on a zinc oxide seed layer in a deposition chamber. After completing the deposition, the chamber is purged and a layer of silver can be deposited on the doped silver layer in the same chamber, without exposing the substrate to outside ambient. Alternatively, a layer of doped silver can be deposited on the substrate, and the dopant source is turned off to enable the deposition of a silver layer on the doped silver layer.

In some embodiments, a sputter deposition chamber can comprise two targets, for example, a silver target and a dopant target or a silver target and an alloy target of silver and the dopant. The silver and dopant targets, or the alloy target, can be used to deposit a doped silver layer. The dopant target or the alloy target, is then turned off (e.g., shutting off power or shielding the target), leaving the silver target to deposit a silver layer.

In some embodiments, the present bottom layer can provide improved silver layer with thinner film thickness. In some embodiments, the present invention discloses methods and materials for improving adhesion of a silver layer on a substrate, comprising a first doped silver layer under a second silver layer. The first doped silver layer comprises a doping element that can easily form oxides to create a strong bond with the substrate, or with an underlayer or a seed layer disposed on the substrate. The second silver layer can have improved adhesion, agglomeration and conductivity due to the first doped silver layer. The thickness of the first doped silver layer can be less than about 5 nm, and preferably between about 0.5 nm and 3 nm. The thickness of the second silver layer can be less than about 10 nm, and preferably less than 7 nm.

In some embodiments, the doping element comprises an element that has lower enthalpy of oxide formation as compare to that of silver. The term “lower enthalpy” is used in the algebraic sense, meaning having a larger negative value of enthalpy, or having a smaller positive value of enthalpy. For example, silver has enthalpy of oxide formation of about −30 kJ/mol, i.e., the enthalpy of formation of silver oxide is about −30 kJ/mol. Therefore by doping silver with a doping element with lower enthalpy of oxide formation, the doped silver can be oxidized easier, potentially creating stronger bonds with an oxide underlayer. In some embodiments, the doping element can have enthalpy of formation of less than about −30 kJ/mol, less than about −80 kJ/mol, or less than about −300 kJ/mol. The doping element can be Ti, Si, Pd, Cr, Ni, Zr, Mn, Fe, Ta, Pt, or Zn, which have enthalpies of oxide formation ranging from about −85 kJ/mol for Pd to about −2046 kJ/mol for Ta. The doping concentration can be less than 10 wt %, and preferably less than 5 wt %.

In some embodiments, the doping element comprises an element that has lower enthalpy of oxide formation as compare to that of the underlayer. For example, for an underlayer of ZnO, which has an enthalpy of formation of −348 kJ/mol, the doping element can comprise element that has enthalpy of oxide formation of lower than about −348 kJ/mol. The doping element can be Ti, Si, Cr, Zr, Mn, Fe, Ta, or Zn, which have enthalpies of oxide formation ranging from about −520 kJ/mol for Mn to about −2046 kJ/mol for Ta. The doping concentration can be less than 10 wt %, and preferably less than 5 wt %.

In some embodiments, the present invention discloses methods to form seed layer, bottom layer, and silver layer, comprising thin film deposition methods such as physical vapor deposition (PD), chemical vapor deposition (CVD), atomic layer deposition (ALD), or wet chemical deposition methods such as electroplating or electroless deposition.

In some embodiments, the present invention discloses an improved coated transparent panel, such as a coated glass, that has high visible light transmission and IR reflection. The present invention also discloses methods of producing the improved, coated, transparent panels, which comprise specific layers in a coating stack.

In some embodiments, the present invention discloses coated panels comprising a doped silver layer under a silver layer to improve adhesion. Other layers can be included, such as base layer, seed layer, antireflective layer, barrier layer and protective layer.

In some embodiments, the present invention discloses sputter systems, and methods to operate the sputter systems, for making coated panels, comprising a doped target together with a silver target to deposit a first layer of doped silver under a layer of silver on a transparent substrate. In some embodiments, the present invention discloses an in-line deposition system, comprising a transport mechanism for moving substrates between deposition stations.

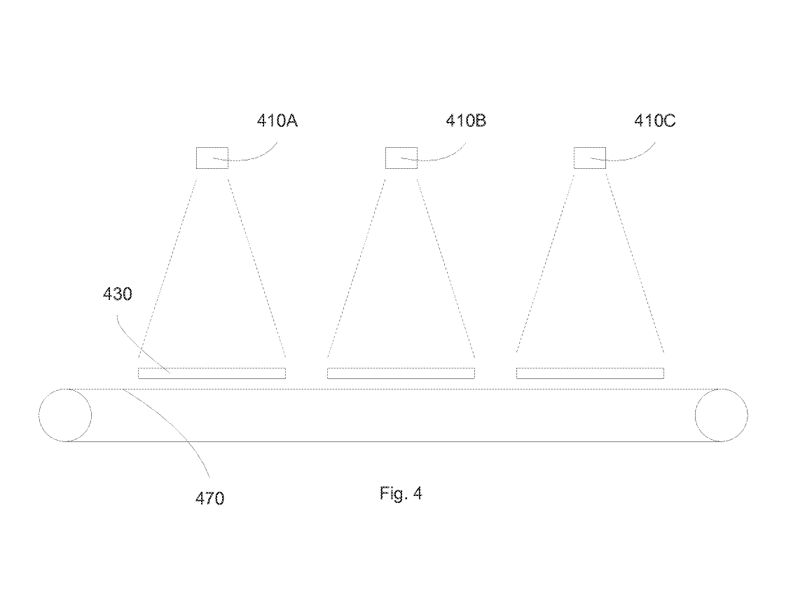

FIG. 4 illustrates an exemplary in-line deposition system according to some embodiments of the present invention. A transport mechanism 470, such as a conveyor belt or a plurality of rollers, can transfer substrate 430 between different sputter deposition stations. For example, the substrate can be positioned at station #1, comprising a target assembly 410A, then transferred to station #2, comprising target assembly 410B, and then transferred to station #3, comprising target assembly 410C. Station #1 can be configured to deposit a seed layer, for example, a zinc oxide layer, which can comprise (002) crystal orientation. Station #2 can be configured to deposit a doped silver layer, which comprises an alloy of silver with a dopant. The amount of dopant is preferably less than 5%, for example, to enable a growth of (111) crystal orientation on the seed layer. Station #3 can be configured to deposit a silver layer, which can comprise (111) crystal orientation. As shown, the target assembly 4108 comprises silver alloy material, e.g., a mixture of silver and a dopant material. Other configurations can be included, for example, station #2 can comprise two target assemblies for co-sputtering, such as a target assembly comprising a dopant material and a target assembly comprising silver. In some embodiments, station #3 having target assembly 410C comprising silver can be optional, and deposition of the silver layer can be performed in station #2, for example, through the target assembly comprising silver. In addition, other stations can be included, such as input and output stations, or anneal stations.

A first layer can be deposited in station #1, for example, a zinc oxide layer having (002) crystal orientation. The (002) crystal orientation of the deposited zinc oxide layer can serve as a template for the subsequently deposited silver layer (in station #2 or station #3). The substrate is moved to station #2, where a doped silver layer can be deposited. The substrate is then transferred to station #3 to deposit a silver layer over the doped silver layer. Alternatively, the substrate can stay in station #2 for depositing the silver layer. The (111) crystal orientation of the silver layer can be improved by the (002) orientation of the zinc oxide seed layer.

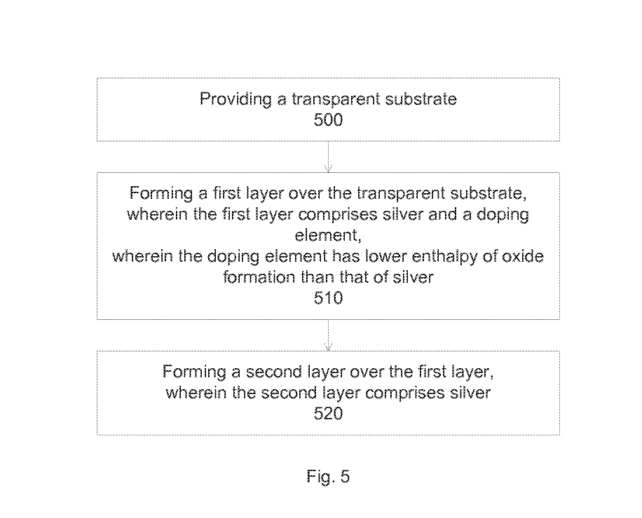

FIG. 5 illustrates an exemplary flow chart for two layer silver deposition according to some embodiments of the present invention. In operation 500, a transparent substrate is provided. In operation 510, a first layer is formed on the transparent substrate. In some embodiments, the first layer comprises silver and a doping element. The first layer can comprise a doping element that has a lower enthalpy of oxide formation than that of silver, such as having lower enthalpy of oxide formation than about −50 kJ/mol. In some embodiments, the doping element can have a lower enthalpy of oxide formation than that of zinc, such as having a lower enthalpy of oxide formation than about −350 kJ/mol.

In some embodiments, the doping element can be at least one of Ti, Si, Pd, Cr, Ni, Zr, Mn, Fe, Ta, Pt, and Zn. In some embodiments, the first layer is preferably thin, for example, less than or equal to about 3 nm. In some embodiments, the thickness of the first layer is greater than about 0.5 nm. The first layer can be continuous across the substrate surface. Alternatively, the first layer can form separated or adjacent sections on the substrate surface. In some embodiments, the thickness of the sections can be between about 0.2 nm to about 0.4 nm.

In some embodiments, the doping element is selected to provide better adhesion with the second layer. Also, the doping element can be selected to provide less agglomeration for the second layers as compared to a second layer in a layer stack without the first layer.

In some embodiments, the first layer comprises less than or equal to about 5 wt % of the doping material. The first layer can comprise (111) crystal orientation.

In some embodiments, some portion of the first layer is converted to an oxide layer, for example, during or after the formation of the subsequent layer or during an additional annealing step. The partial oxidation of the metallic element in the first layer can produce strong bonding to the surrounding layers, such as bonding to the silicate glass substrate or to a bottom zinc oxide layer. The enhanced bonding can improve the integrity and the durability of the resulting layer structure.

In operation 520, a second layer is formed on the first layer. In some embodiments, the second layer comprises silver, e.g., forming a pure silver layer. In some embodiments, the second layer can comprise (111) crystal orientation.

In some embodiments, the second layer is formed on the first layer without being exposed to the ambient environment, e.g., ambient air. The control of the sequence deposition of the first and second layers can enhance the adhesion between the first and second layers. In some embodiments, the second layer is less than or equal to about 10 nm.

In some embodiments, other layers can be deposited, before the first layer or after the second layer. In some embodiments, an annealing step can be performed in an oxygen-containing ambient, for example, after forming the second layer. The annealing step can partially oxidize the first layer, forming an at least partially oxidized first layer.

In some embodiments, a photovoltaic device, a LED (light emitting diode) device, a LCD (liquid crystal display) structure, or an electrochromic layer is formed on the substrate having the layer structure.

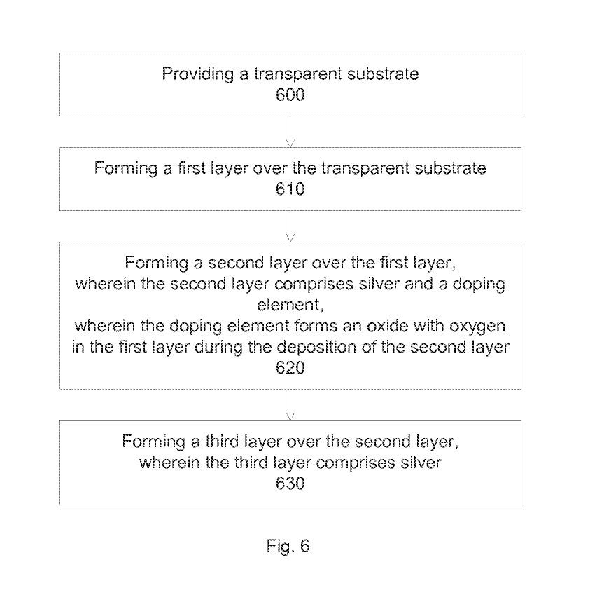

FIG. 6 illustrates another exemplary flow chart for two layer silver deposition according to some embodiments of the present invention. In operation 600, a transparent substrate is provided. In operation 610, a first layer is formed on the transparent substrate. In some embodiments, the first layer comprises zinc oxide, e.g., a zinc oxide containing layer such as a zinc oxide layer or a doped zinc oxide layer. The first layer can comprise a (002) crystal orientation, for example, to promote a (111) crystal orientation of a subsequently deposited silver layer.

In operation 620, a second layer is formed on the first layer. In some embodiments, the second layer comprises silver and a doping element, for example, to serve as a bottom layer for a subsequently deposited silver layer. In operation 630, a third layer is deposited on the second layer. In some embodiments, the third layer comprises silver.

Although the foregoing examples have been described in some detail for purposes of clarity of understanding, the invention is not limited to the details provided. There are many alternative ways of implementing the invention. The disclosed examples are illustrative and not restrictive.

What is claimed is:

1. A method for making a coated article, the method comprising:
providing a transparent substrate;
forming a first layer over the transparent substrate, wherein the first layer comprises silver and a doping element, and wherein the doping element comprises at least one of Ti, Si, Cr, Zr, Mn, Fe, Ta, and Pt; and
forming a second layer over the first layer, wherein the second layer is in direct contact with the first layer, and wherein the second layer comprises silver.

2. A method as in claim 1 further comprising forming a seed layer over the transparent substrate, wherein the seed layer has a (002) crystallographic orientation, and the first layer is formed over and in direct contact with the seed layer.

3. A method as in claim 1 wherein the concentration of the doping element is 5 wt % or less.

4. A method as in claim 1 wherein the thickness of the first layer is less than 3 nm.

5. A method as in claim 1 wherein the enthalpy of oxide formation of the doping element is less than that of Zn.

6. A method for making a coated article, the method comprising:
providing a transparent substrate;
forming a first layer over the transparent substrate, wherein the first layer comprises zinc oxide;
forming a second layer over the first layer, wherein the second layer comprises silver and a doping element, and wherein the doping element comprises at least one of Ti, Si, Cr, Zr, Mn, Fe, Ta, and Pt; and
forming a third layer over the second layer, wherein the third layer is in direct contact with the second layer, and wherein the third layer comprises silver.

7. A method as in claim 6 wherein the first layer has a (002) crystallographic orientation, and the second layer is in direct contact with the first layer.

8. A method as in claim 6 wherein the concentration of the doping element is 5 wt % or less.

9. A method as in claim 6 wherein the thickness of the second layer is less than 3 nm.

10. A method as in claim 6 wherein the enthalpy of oxide formation of the doping element is less than −50 kJoules/mol.

11. A method as in claim 6 wherein the thickness of the third layer is less than 10 nm.

12. A method as in claim 6 further comprising depositing a fourth layer over the transparent substrate, wherein the fourth layer is operable as an antireflective layer.

13. A method as in claim 6 further comprising depositing a fifth over the third layer, wherein the fifth layer is operable as a barrier layer.

14-20. (canceled)
